(19) United States
(12) Patent Application Publication
(10) Pub. No.: US 2011/0265040 A1
(43) Pub. Date: Oct. 27, 2011

(54) METHOD FOR PROVIDING GRAPHICAL USER INTERFACE AND MOBILE DEVICE ADAPTED THERETO

(75) Inventors: Hyun Kyung SHIN, Seoul (KR); Seung Woo SHIN, Seoul (KR); Bong Won LEE, Seoul (KR); In Won JONG, Seoul (KR)

(73) Assignee: Samsung Electronics Co., LTD., Gyeonggi-Do (KR)

(21) Appl. No.: 13/084,651

(22) Filed: Apr. 12, 2011

(30) Foreign Application Priority Data
Apr. 22, 2010 (KR) 10-2010-0037511

(51) Int. Cl. G06F 3/048

(52) U.S. Cl. 715/830

(57) ABSTRACT

A method for providing a Graphic User Interface (GUI) and a touch screen-based mobile device adapted thereto permit the user to be notified that additional items are available for display. The method preferably includes: determining whether there is an item to be displayed, other than at least one item arranged in an item display allocation area; and displaying, when there is an item to be displayed, an image object, shaped as a certain shape, at a boundary portion of the item display allocation area at which the item to be displayed is created. The intensity, color, pattern, etc. of the image at the boundary can be varied in accordance with the number and urgency of non-displayed items.

### CLAIM OF PRIORITY

This application claims priority from Korean Patent Application No.: 10-2010-0037511, filed Apr. 22, 2010, the contents of which are incorporated by reference in their entirety.

### BACKGROUND OF THE INVENTION

1. Field of the Invention

The present invention relates to communication systems. More particularly, the present invention relates to a method that provides a Graphical User Interface (GUI) related to a user's touches and a touch screen-based mobile device adapted thereto.

2. Description of the Related Art

User preference for touch screen-based mobile devices has been gradually increasing over devices without touch sensitivity. Touch screen-based mobile devices allow users more flexibility by inputting their gestures on the touch screen to search for information or to perform functions. To this end, the mobile devices display a Graphical

User Interface (GUI) on the touch screen, so that they can guide users' touch gestures. The convenience of the mobile devices varies according to the types of GUI displayed on the touch screen. Research regarding GUI has been performed to enhance the convenience of mobile devices when being programmed to accept gestures.

### SUMMARY OF THE INVENTION

The present invention provides system and a method for providing a Graphical User Interface (GUI) to enhance the convenience of mobile devices.

The invention further provides a mobile device adapted to the method.

In accordance with an exemplary embodiment of the invention, the invention provides a method for providing a Graphic User Interface (GUI) in a mobile device, which preferably includes: determining whether there is an additional item to be displayed other than at least one item currently arranged in an item display allocation area; and displaying, when it is determined that there is an item to be displayed, an indicator comprising an image object shaped as a certain predetermined shape or shapes, at a boundary portion of the item display allocation area at which the item to be displayed is created.

In accordance with another exemplary embodiment of the invention, the invention provides a method for providing a GUI in a mobile device, which preferably includes: determining, while at least one application including a first application is being executed, whether a user's command has been input to execute a second application;

displaying a graphic object shaped as a predetermined shape on a specific region in an execution screen of the second application; sensing a touch gesture input to the graphic object; and displaying a screen related to the first application according to the sensed touch gesture.

In accordance with another exemplary embodiment of the invention, a mobile device preferably includes: a display unit for displaying screens; and a controller for controlling the display unit to arrange and display at least one item on an item display allocation area, determining whether there is an item to be displayed other than said at least one item. The controller further controls, when there is an item to be displayed, the display unit 132 to display an image object, shaped as a certain shape, at a boundary portion of the item display allocation area at which the item to be displayed is created.

Preferably, the mobile device may further include a touch screen unit for sensing a user's touch gestures. The controller executes at least one application including a first application, and then preferably receives a user's command for executing a second application via the touch screen unit. The controller preferably controls the display unit to display a graphic object, shaped as a certain (i.e. predetermined) shape, in a region of an execution screen of the second application. The controller also preferably controls the touch screen unit to sense a user's touch gesture input to the graphic object. The controller can further control the display unit to overlay and display a control window of the first application on the execution screen of the second application, or to switch the execution screen from the second application to the first application, according to the sensed touch gesture.

### BRIEF DESCRIPTION OF THE DRAWINGS

The features and advantages of the invention will become more apparent from the following detailed description in conjunction with the accompanying drawings, in which:

FIG. 1 illustrates a configuration of a mobile device according to an exemplary embodiment of the invention;

FIG. 2 illustrates a flowchart that describes a first exemplary embodiment of a method for providing a Graphical User Interface (GUI) related to a mobile device, according to the invention;

FIG. 3A illustrates a first exemplary example of screens displayed on a mobile device, according to the first exemplary embodiment of a method for providing a GUI;

FIG. 3B illustrates a second exemplary example of screens displayed on a mobile device, according to the first exemplary embodiment of a method for providing a GUI;

FIG. 3C illustrates a third exemplary example of screens displayed on a mobile device, according to the first exemplary embodiment of a method for providing a GUI;

FIG. 4 illustrates a screen that describes an illumination direction of a light image displayed on a screen, according to the first exemplary embodiment of a method;

FIGS. 5A and 5B illustrate screens displayed on a mobile device, varied when a user input a touch movement gesture, according to the first exemplary embodiment of a method for providing a GUI;

FIG. 6 illustrates a flowchart that describes a second exemplary embodiment of a method for providing a GUI related to a mobile device, according to the invention;

FIGS. 7A and 7B illustrate a first exemplary example of screens displayed on a mobile device, according to the second exemplary embodiment of a method for providing a GUI; and

FIGS. 8A and 8B illustrate a second exemplary example of screens displayed on a mobile device, according to the second exemplary embodiment of a method for providing a GUI.

### DETAILED DESCRIPTION

Hereinafter, exemplary embodiments of the invention are described in detail with reference to the accompanying drawings. The same reference numbers are used throughout the drawings to refer to the same or similar parts. For the purposes of clarity and simplicity, detailed descriptions of well-known functions and structures incorporated herein may be omitted to avoid obscuring appreciation of the subject matter of the invention by a person of ordinary skill in the art.

Prior to explaining the exemplary embodiments of the invention, terminologies will be defined for the present description below. The terms or words described in the present description and the claims should not be limited by a general or lexical meaning, instead should be analyzed as a meaning and a concept through which the inventor defines and describes the invention at his best effort, to comply with the idea of the invention. Therefore, one skilled in the art will understand that the exemplary embodiments disclosed in the description and configurations illustrated in the drawings are only preferred exemplary embodiments, and there may be various modifications, alterations, and equivalents thereof within the spirit and scope of the claimed invention.

In the following description, although an exemplary embodiment of the invention is explained based on a mobile device equipped with a touch screen, it should be understood that the invention is not limited to this exemplary embodiment shown and described herein. It will be appreciated that the invention can be applied to all information communication devices, multimedia devices, and their applications, when they are equipped with a touch screen, for example, a mobile communication terminal, a Portable Multimedia Player (PMP), a Personal Digital Assistant (PDA), a smart phone, an MP3 player, a table computer, a GPS unit, etc.

In particular, the term ‘item’ refers to Graphic User Interface (GUI), and will be used as a concept that includes all types of graphic objects that the user can select.

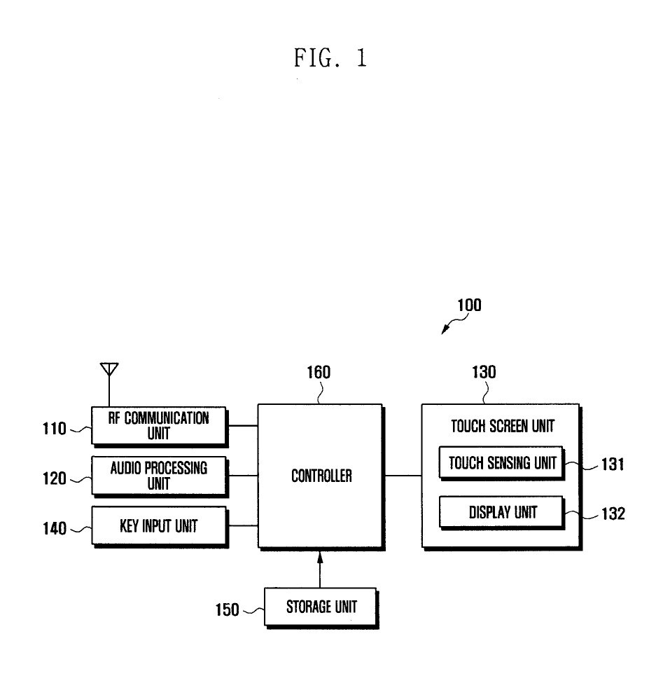

FIG. 1 illustrates a preferable configuration of a mobile device 100 according to an exemplary embodiment of the present invention. The mobile device 100 includes an RF communication unit 110, an audio processing unit 120, a touch screen unit 130, a key input unit 140, a storage unit 150, and a controller 160.

As shown in FIG. 1, the RF communication unit 110 wirelessly transmits and receives data to and from other communication systems. The RF communication unit 110 includes an RF transmitter for up-converting the frequency of signals to be transmitted and amplifying the signals and an RF receiver for low-noise amplifying received RF signals and down-converting the frequency of the received RF signals. The RF communication unit 110 receives data via an RF channel and outputs it to the controller 160. The RF communication unit 110 also transmits data, output from the controller 160, via the RF channel.

The audio processing unit 120 includes coders and decoders (CODECs). The CODECs are comprised of a data CODEC for processing packet data, etc. and an audio CODEC for processing audio signals, such as voice signals, etc. The audio CODEC converts digital audio signals into analog audio signals and outputs them via a speaker (SPK). The audio CODEC also converts analog audio signals, received via a microphone (MIC), into digital audio signals.

Still referring to FIG. 1, the touch screen unit 130 includes a touch sensing unit 131 and a display unit 132. The touch sensing unit 131 senses a user's touches. The touch sensing unit 131 may be implemented with various types of touch sensors, for example, a capacitive overlay type sensor, a resistive overlay type sensor, an infrared beam type sensor, a pressure sensor, etc. It should be understood that the invention is not limited to the sensors listed above, which are only provided as some possible non-limiting examples. That is, the touch sensing unit 131 can be implemented with all types of sensors when they can sense touch or contact or pressure. The touch sensing unit 131 senses a user's touches applied to the touch screen 130, generates sensed signals, and outputs them to the controller 160. The sensed signals include coordinate data of a user's input touches. For example, when the user gestures movement of a touch position on the touch screen 130, the touch sensing unit 131 creates a sensed signal including coordinate data of the movement path of the touch position and then transfers it to the controller 160. In an exemplary embodiment of the present invention, the movement gesture of a touch position includes a flick and a drag. The flick is a gesture where the movement speed of a touch position exceeds a preset value. Likewise, the drag is a gesture where the movement speed is less than the preset value.

With continued reference to FIG. 1, the display unit 132 may be implemented with a Liquid Crystal Display (LCD), an Organic Light Emitting Diode (OLED), an Active Matrix Organic Light Emitting Diodes (AMOLED), or the like. The display unit 132 displays a variety of items such as menus, input data, function-setting information, and addition information. For example, the display unit 132 displays a booting screen, an idle screen, a call screen, and screens for executing applications of the mobile device 100.

The key input unit 140 receives a user's key operating signals for controlling the mobile device 100, creates input signals, and outputs them to the controller 160. The key input unit 140 may be implemented with a keypad with alphanumeric keys and direction keys. The key input unit 140 may also be implemented as a function key at one side of the mobile device 100. When the mobile device 100 is implemented so that it can be operated by only the touch screen 130, the mobile device may not be equipped with the key input unit 140.

The storage unit 150 stores programs required to operate the mobile device 100 and data generated when the programs are executed. The storage unit 150 is comprised of a program storage area and a data storage area.

The program storage area of storage unit 15 stores an operating system (OS) for booting the mobile device 100, application programs required to playback multimedia contents, etc., and other application programs that are necessary for other optional functions, such as a camera function, an audio reproduction function, photographs or moving images reproduction function, etc. When the user requests the respective listed functions in the mobile device 100, the controller 180 activates corresponding application programs in response to the user's request to provide corresponding functions to the user. The data storage area refers to an area where data, generated when the mobile device 100 is used, is stored. That is, the data storing area stores a variety of contents, such as photographs, moving images, a phone book, audio data, etc.

The controller 160 controls the entire operation of the mobile device 100.

In a first exemplary embodiment, the controller 160 controls the touch sensing unit 131 or the key input unit 140 and determines whether a user inputs a command for displaying an item. When the controller 160 ascertains that a user inputs a command for displaying an item, the controller controls the display unit 132 to display at least one item on an item display allocation area in a certain direction. After that, the controller 160 determines whether or not the item can be moved in the item arrangement direction or in the opposite direction. The controller 160 also determines whether there is an item in a display waiting state before the foremost item from among the items currently displayed or after the last item from among the items currently displayed. When the controller 160 ascertains that the item can be moved in the item arranged direction, the controller controls the display unit 132 to display a light image at the boundary portion of the item display allocation area at the location where the item arrangement starts. On the contrary, when the controller 160 ascertains that the item can be moved in the direction opposite to the item arranged direction, the controller controls the display unit 132 to display a light image at the boundary portion of the item display allocation area at the location where the item arrangement ends.

In a second exemplary embodiment, the controller 160 controls the display unit 132 to display an execution screen of a first application according to a user's input. The controller 160 also controls the touch screen unit 130 or the key input unit 140 and determines whether the user inputs a command for executing a second application. When the controller 160 ascertains that the user inputs a command for executing a second application, the controller controls the display unit 132 to switch the execution screen from the first application to the second application. After that, the controller 160 preferably controls the display unit 132 to display a light image (i.e. illuminated image) at a certain area in the execution screen of the second application. While the light image is being displayed on the execution screen of the second application, the controller 160 controls the touch screen unit 130 and determines whether the user inputs a touch gesture in a certain direction toward the light image. When the controller 160 ascertains that the user inputs a touch gesture in a certain direction toward the light image, the controller controls the display unit 132 and overlays and displays a control window of the first application on the execution screen of the second application.

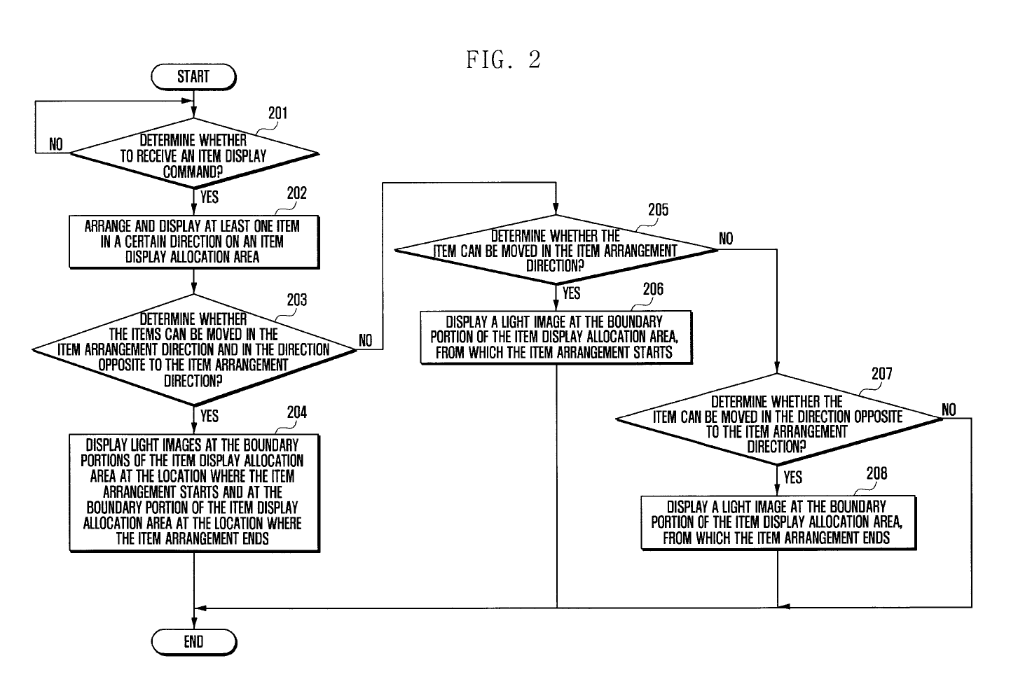

FIG. 2 illustrates a flowchart that describes a first exemplary embodiment of a method for providing a Graphical User Interface (GUI) related to a mobile device 100, according to the invention. In the first exemplary embodiment, the method provides a GUI to allow the user to browse items not displayed on the display unit 132.

The controller 160 (FIG. 1) determines whether to receive an item display command (201). The controller 160 controls the touch sensing unit 131 or the key input unit 140 to determine whether a command for displaying a background including at least one item is input at step 201. Alternatively, the controller 160 controls the touch sensing unit 131 or the key input unit 140 to determine whether or not a command for displaying a menu screen or an execution screen of an application, including at least one item, is input at step 201. In an exemplary embodiment, an item refers to a higher menu item including a number of sub-menu items.

With continued reference to the flowchart in FIG. 2, when the controller 160 ascertains that an item display command has been received by the input unit at step 201, the controller controls the display unit 132 to arrange and display at least one item in a certain direction on an item display allocation area (202). In this description, the ‘item display allocation area’ refers to an area where one or more items are displayed. The controller 160 identifies an item display allocation area on the display unit 132. The controller 160 detects the maximum number ‘M’ of items that can be displayed in the item display allocation area, and then the number ‘m’ of items to be displayed. After that, the controller 160 compares the maximum number ‘M’ of items with the number ‘m’ of items. When the maximum number ‘M’ of items is equal to or greater than the number ‘m’ of items, the controller 160 controls the display unit 132 to arrange and display all items in a certain direction in the item display allocation area. On the contrary, when the maximum number ‘M’ of items is less than the number ‘m’ of items, all items to be displayed cannot be displayed in the item display allocation area at the same time. In that case, the controller 160 controls the display unit 132 to select only M items from among the items to be displayed and to display them in the item display allocation area. In an exemplary embodiment, when the order of arrangement of items to be displayed is set, the controller 160 controls the display unit 132 to display the M items from the highest priority order. Alternatively, the controller 160 can also control the display unit 132 to display the M items from the lowest priority order. The controller 160 controls the display unit 132, and returns to and displays the state for displaying the last item. For example, it is assumed in this example that a background screen includes a number of items that have determined the order of arrangement. When a command is input to switch the background screen to another screen in a state where the second highest priority item is foremost displayed, and then to return to and to display the original background screen, the controller 160 controls the display unit 132 and arranges and displays the items so that the second highest priority item is foremost displayed.

At step 202, the controller 160 controls the display unit 132 and arranges and displays items in a certain direction. For example, items may be displayed by being arranged from left to right or from right to left. Alternatively, the items may also be displayed by being arranged from top to bottom or from bottom to top. It should be understood that the invention is not limited to the arrangement directions described above. For example, the exemplary embodiment may also be implemented in such a manner that the items may be arranged in a direction, such as, from top left to bottom right, from top right to bottom left, and any other directions if they can be arranged in a direction on the display unit. In addition, the controller 160 can control the display unit 132 to arrange and display items in a number of directions. For example, the items may be displayed in both directions such as from left to right and from top to bottom, i.e., a cross shape.

When the maximum number ‘M’ of items that can be displayed in the item display allocation area is less than the number ‘m’ of items to be displayed (M<n), only M items from among the number ‘m’ of items, i.e., part of the number ‘m’ items, are displayed on the display unit 132, and the remaining number of items (m-M) are not displayed. The remaining number of items (m-M), not displayed, serve as items in a display waiting state. In this description, an ‘item in a display waiting state’ refers to an item that is not currently displayed on the display unit 132 but may be displayed in the item display allocation area according to a user's input.

After arranging and displaying at least one item in a certain direction on an item display allocation area at step 202, the controller 160 determines whether the items can be moved in the item arrangement direction and in the direction opposite to the item arrangement direction (203). This reason is to determine whether there are items to be additionally displayed, other than the items displayed on the display unit 132. At step 203, the controller 160 may determine whether there is an item in a display waiting state before the foremost item from among the currently displayed items or after the last item from among the currently displayed items. In addition, at step 203, the controller 160 may also determine whether, from among the items currently displayed, the foremost displayed item corresponds to the highest priority item in a preset arrangement order of items or the last displayed item corresponds to the lowest priority item in a preset arrangement order of items.

When the controller 160 ascertains that the items can be moved in the item arrangement direction and in the direction opposite to the item arrangement direction at step 203, the controller controls the display unit 132 to display light images at the boundary portion of the item display allocation area at the location where the item arrangement starts and at the boundary portion of the item display allocation area at the location where the item arrangement ends (204). The ‘boundary portion of the item display allocation area at the location where the item arrangement starts’ refers to a boundary portion where hidden items start to appear on the display unit 132. The ‘light image’ refers to an image of a light source illuminating the display unit 132 in a certain direction. Although the exemplary embodiment describes the light image as a light source image, it should be understood that the invention is not limited to the embodiment. In addition, the image displayed at the boundary portion of the item display allocation area may also be implemented with any other images if they can indicate the direction. When the items are arranged in a direction from left to right, the item arrangement starts at the left side and ends at the right side. When the item display allocation area has a substantially rectangular shape, the boundary portion of the item display allocation area at the location where the item arrangement starts is the left side of the rectangle, and similarly the boundary portion of the item display allocation area at the location where the item arrangement ends is the right side of the rectangle. In that case, the light image is displayed at the right and left sides respectively.

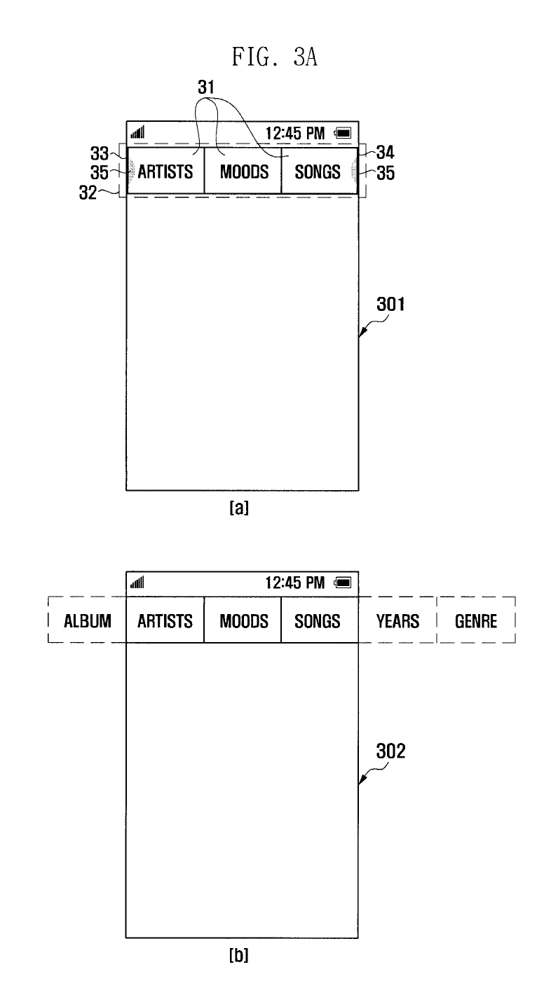

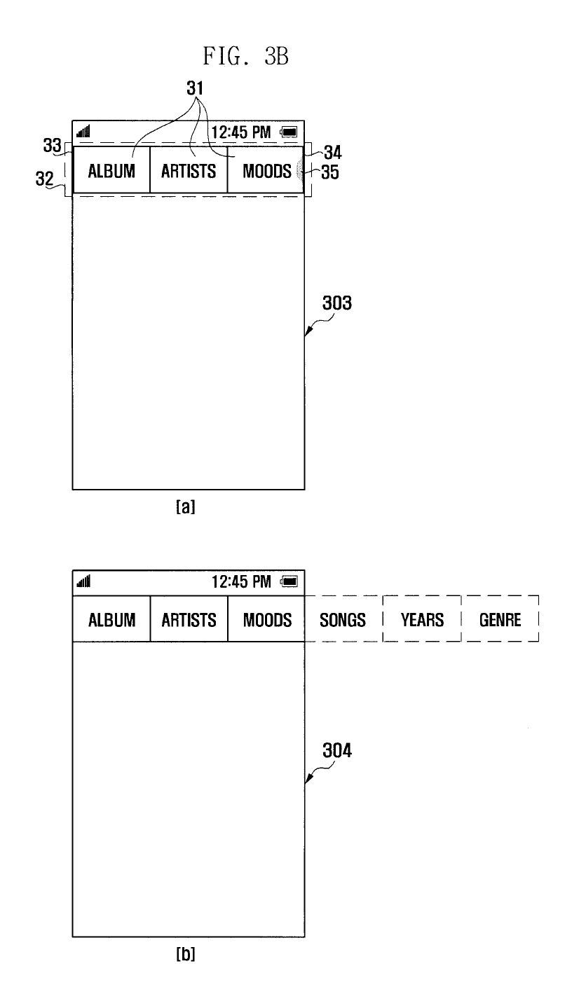

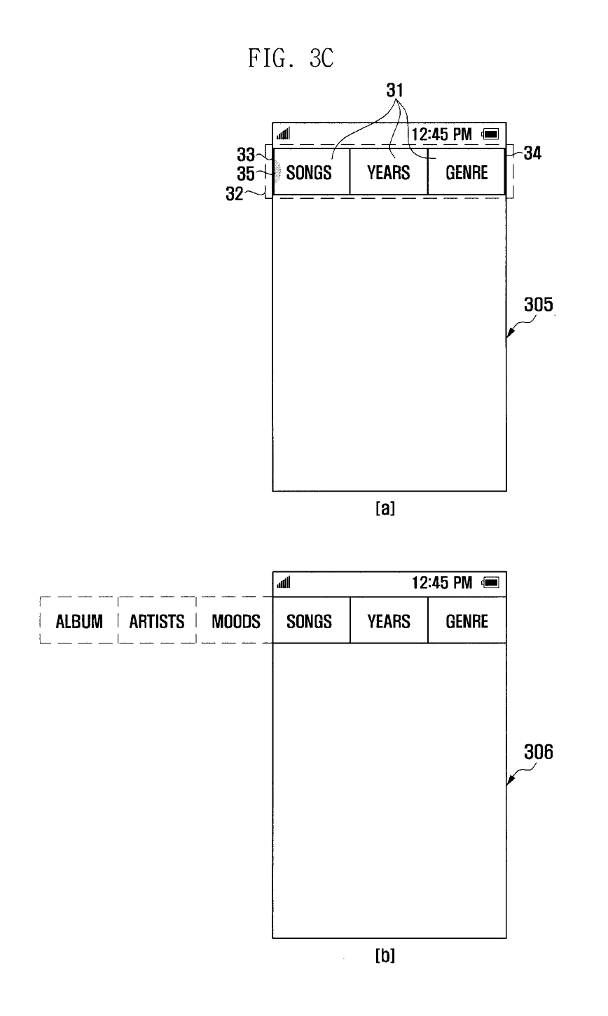

FIG. 3A illustrates a first exemplary example of screens displayed on a mobile device 100, according to the first exemplary embodiment of a method for providing a GUI.

As shown in diagram 301, the screen shows three items 31 i.e., ‘Artists,’ ‘Moods,’ and ‘Songs’, an item display allocation area 32, a first boundary 33 of the item display allocation area 32, a second boundary 34 of the item display allocation area 32, and two light images 35. The three items are arranged in a direction from left to right. The first boundary 33 refers to the boundary portion of the item display allocation area 32 from which the item arrangement starts. Likewise, the second boundary 34 refers to the boundary portion of the item display allocation area 32 from which the item arrangement ends.

With regard to the example shown in FIG. 3A, it is assumed that the item display allocation area may show ‘Album,’ ‘Artists,’ ‘Moods,’ ‘Songs,’ ‘Years,’ and ‘Genre,’ as exemplary items to be displayed, and they are arranged in this example according to the order shown in the diagram. It is also assumed that the maximum number ‘M’ of items to be displayed in the item display allocation area is three. Therefore, the item display allocation area cannot show all six items at once at step 202. That is, the item display allocation area 32 in this example can display only three of the six items. For example, as shown in diagram 302, ‘Artists,’ ‘Moods,’ and ‘Songs’ are displayed in the item display allocation area, and the remaining items, ‘Album,’ ‘Years,’ and ‘Genre,’ are in a display waiting state. ‘Album’ is located before ‘Artist’ and is in a display waiting state. Similarly, ‘Years,’ and ‘Genre,’ are located after ‘Songs’ and are in a display waiting state. Since there is an item ‘Album’ in a display waiting state before the foremost item ‘Artist’ being displayed in the item display allocation area, the controller 160 controls the display unit 132 to display the light image 35 at the first boundary 33 of the item display allocation area 32 as shown in diagram 301 of FIG. 3A. Similarly, since there are items ‘Years’ and ‘Genre’ in a display waiting state after the last item ‘Songs’ being displayed in the item display allocation area, the controller 160 controls the display unit 132 to display the light image 35 at the second boundary 34 of the item display allocation area 32 as shown in diagram 301 of FIG. 3A.

When the user views the light image 35 at the first 33 and second 34 boundaries of the item display allocation area 32, he/she can be made aware that there are additional items to be displayed before ‘Artists’ item and after ‘Songs’ item.

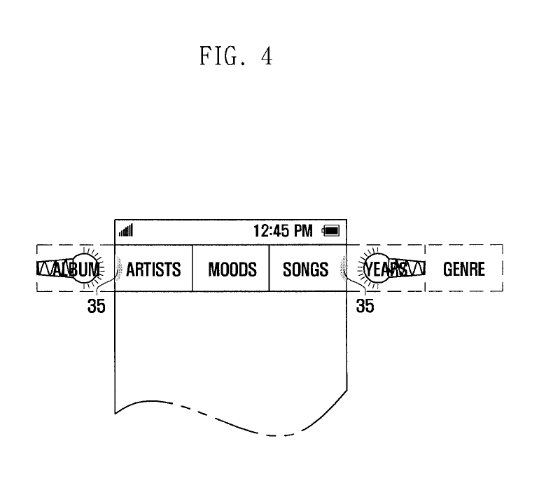

The controller 160 controls the display unit 132 to display a light image as if the light illuminates light from an item in a display waiting state to an item in the item display allocation area. This is shown in FIG. 4. FIG. 4 illustrates a screen that describes an illumination direction of a light image 35 displayed on a screen, according to the first exemplary embodiment of a method. As shown in FIG. 4, the light image 35 is located at the boundary line between the items ‘Album’ and ‘Artists,’ and illuminates light as if illuminated from the item in a display waiting state, ‘Album,’ to the item in the item display allocation area, ‘Artist.’ Likewise, the light image 35 is also located at the boundary line between the items ‘Years’ and ‘Songs,’ and illuminates light as if illuminated from the item in a display waiting state, ‘Years,’ to the item in the item display allocation area, ‘Songs.’

Meanwhile, when the controller 160 ascertains that the items cannot be moved in the item arrangement direction and in the direction opposite to the item arrangement direction at step 203, the controller determines whether the item can be moved in the item arrangement direction (205) (FIG. 2). Step 205 can also be performed in such a manner that the controller 160 determines whether there is an item in a display waiting state before the foremost item from among the items currently displayed. Alternatively, step 205 can also be performed in such a manner that the controller 160 determines whether the foremost item from among the items currently displayed corresponds to the highest priority item in a preset arrangement order.

When the controller 160 ascertains that the item can be moved in the item arrangement direction at step 205, the controller controls the display unit 132 to display a light image at the boundary portion of the item display allocation area, at which the item arrangement starts (206).

FIG. 3B illustrates a second exemplary group of screens displayed on a mobile device 100, according to the first exemplary embodiment of a method for providing a GUI. With regard to the example shown in FIG. 3B, it is assumed that the item display allocation area may show ‘Album,’ ‘Artists,’ ‘Moods,’ ‘Songs,’ ‘Years,’ and ‘Genre,’ as items to be displayed, and they are arranged according to the order shown in diagrams 303 and 304. The items are arranged in a direction from the left to the right. It is also assumed that the maximum number ‘M’ of items to be displayed in the item display allocation area is three. For example, as shown in diagram 304, ‘Album,’ ‘Artists,’ and ‘Moods’ are displayed in the item display allocation area, and the remaining items, ‘Songs,’ ‘Years,’ and ‘Genre,’ are in a display waiting state, being located after the item ‘Moods.’ Since there are no items in a display waiting state before the item ‘Album’ being displayed in the item display allocation area, no item can be moved in the direction from the left to the right. In that case, as shown in diagram 303, the controller 160 does not display the light image 35 at the first boundary 33 of the item display allocation area. On the contrary, since there are items in a display waiting state (e.g., ‘Songs,’ ‘Years,’ and ‘Genre’) after the item ‘Moods’ being displayed in the item display allocation area, they can be moved in the direction from the right to the left. In that case, as shown in diagram 303, the controller 160 controls the display unit 132 to display the light image 35 at the second boundary 34 of the item display allocation area.

Meanwhile, when the controller 160 ascertains that the item cannot be moved in the item arrangement direction at step 205, it determines whether the item can be moved in the direction opposite to the item arrangement direction (207) (FIG. 2). Step 207 can also be performed in such a manner that the controller 160 determines whether there is an item in a display waiting state after the last item from among the items currently displayed in the item display allocation area. Alternatively, step 207 can also be performed in such a manner that the controller 160 determines whether the last item from among the items currently displayed in the item display allocation area corresponds to the lowest priority item of the items arranged in a preset order.

When the controller 160 ascertains that the item can be moved in the direction opposite to the item arrangement direction at step 207, it controls the display unit 132 to display a light image at the boundary portion of the item display allocation area, at which the item arrangement ends (208) (FIG. 2).

FIG. 3C illustrates a third exemplary example of screens displayed on a mobile device 100, according to the first exemplary embodiment of a method for providing a GUI. In order to describe FIG. 3C, it is assumed that the item display allocation area may show ‘Album,’ ‘Artists,’ ‘Moods,’ ‘Songs,’ ‘Years,’ and ‘Genre,’ as items to be displayed, and they are arranged according in the order shown in diagrams 305 and 306. The items are arranged in a direction from the left to the right. It is also assumed that the maximum number ‘M’ of items to be displayed in the item display allocation area is three. For example, as shown in diagram 306, ‘Songs,’ ‘Years,’ and ‘Genre,’ are displayed in the item display allocation area, and the remaining items, ‘Album,’ ‘Artists,’ and ‘Moods,’ are in a display waiting state, being located before the item ‘Songs.’ Since there are no items in a display waiting state after ‘Genre’ being displayed in the item display allocation area, no item can be moved in the direction from the right to the left. In that case, as shown in diagram 305, the controller 160 does not display the light image 35 at the second boundary 34 of the item display allocation area. On the contrary, since there are items in a display waiting state (e.g., ‘Album,’ ‘Artists,’ and ‘Moods’) before the item ‘Songs’ being displayed in the item display allocation area, they can be moved in the direction from the left to the right. In that case, as shown in diagram 305, the controller 160 controls the display unit 132 to display the light image 35 at the first boundary 33 of the item display allocation area.

The controller 160 can control the display unit 132 to display the light image with a certain amount of brightness, or with alteration in the brightness according to the number of items in a display waiting state. The controller 160 can also control the display unit 132 to alter and display the light image according to the feature of the item in a display waiting state. For example, when there is an item in a display waiting state that is required to execute a user's missed event that the user will have to rapidly check, the controller 160 controls the display unit 132 to display a blinking light image. Alternatively, the controller 160 can control the display unit 132 to alter and display the color of a light image according to the feature of the item in a display waiting state. In addition, when the controller 160 ascertains that there is an item in a display waiting state when the controller 160 controls the display unit 132 to first display an item, it displays a light image and checks an elapsed time period. After that, the controller 160 determines whether a certain period of flowing time has elapsed and deletes the light image. When the user touches the touch screen unit 130 in a state where the light image is deleted, the controller 160 can control the display unit 132 to display the light image again.

The light image 35 serves to guide the user to correctly input his/her touch gesture. From the light direction and the display position of the light image, the user can correctly decide which direction he/she must input his/her touch movement gesture to. This guidance can prevent an accidental touch movement gesture by the user. Referring to diagram 301 of FIG. 3A, since the light image 35 is displayed both at the first 33 and second 34 boundaries of the item display allocation area, the user can input touch movement gestures from left to right or from right to left in order to search a corresponding item. When the user touches a certain point in the item display allocation area 32 or in a region where the light image 35 is displayed and then moves the touched position in the right or left direction, the items in a display waiting state, i.e., hidden items, appears in the item display allocation area 32. Referring to diagram 303 of FIG. 3B, since the light image 35 is only displayed at the second boundary 34 of the item display allocation area, the user recognizes that he/she can only perform the touch movement gesture from the right to the left in order to search for a corresponding item. Referring to diagram 305 of FIG. 3C, since the light image 35 is only displayed at the first boundary 33 of the item display allocation area, the user recognizes that he/she can only perform the touch movement gesture from the left to the right in order to search for a corresponding item.

When the user inputs a touch movement gesture on the touch screen unit 130, the controller 160 controls the display unit 132 to move and display items, to delete items currently displayed, and to create and display items in a display waiting state. After that, the controller 160 determines whether item movement can be performed, from the location to which the items are moved, in the item arrangement direction or in the direction opposite to the item arrangement direction. When the controller 160 ascertains that item movement can be performed in the item arrangement direction, it controls the display unit 132 to display a light image at the boundary portion of the item display allocation area, at which the item arrangement starts. On the contrary, when the controller 160 ascertains that item movement can be performed in the direction opposite to the item arrangement direction, it controls the display unit 132 to display a light image at the boundary portion of the item display allocation area, at which the item arrangement ends.

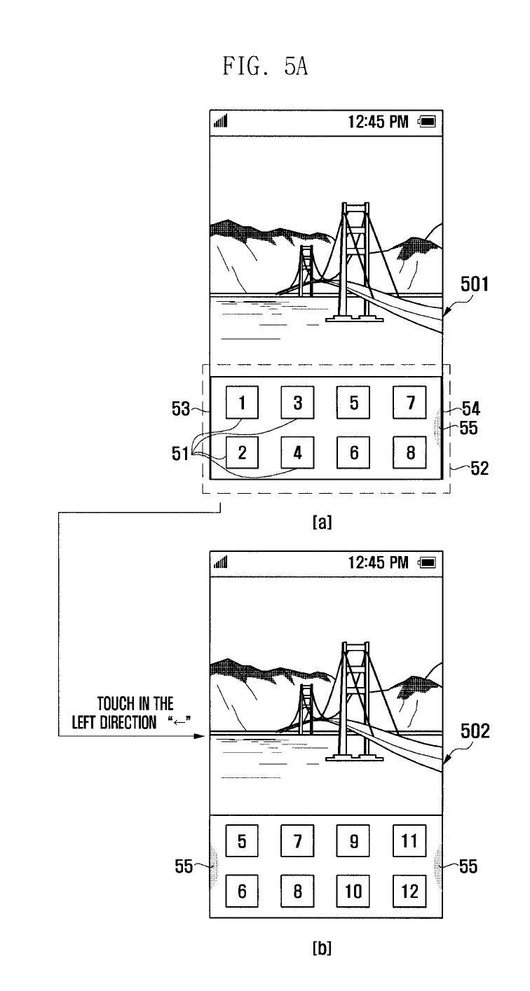

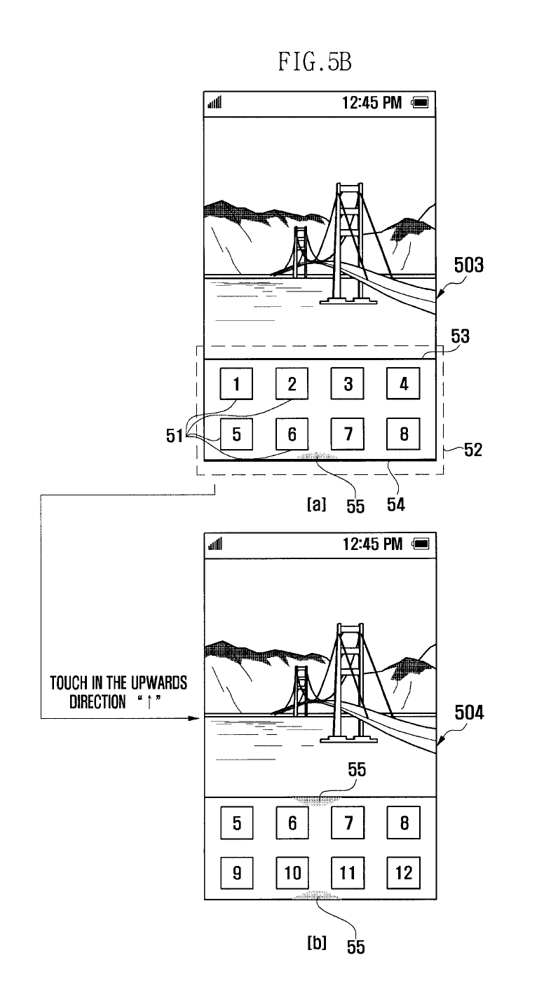

FIGS. 5A and 5B illustrate screens displayed on a mobile device 100, varied when a user inputs a touch movement gesture, according to the first exemplary embodiment of a method for providing a GUI. With regard to the examples shown in FIGS. 5A and 5B, it is assumed that the number of items to be displayed are 15, items ‘1,’ ‘2,’ . . . , ‘15,’ and the maximum number ‘M’ of items to be displayed in an item display allocation area is eight.

As shown in diagram 501 of FIG. 5A, the screen shows eight items ‘1,’ ‘2,’ . . . , ‘8’ (51), an item display allocation area 52, a first boundary 53 of the item display allocation area, a second boundary 54 of the item display allocation area, and a light image 55. The eight items ‘1,’ ‘2,’ . . . , ‘8’ (51) are arranged in four columns each two items in row, in the item display allocation area 52, from the left to the right. The remaining items ‘9,’ ‘10,’ . . . , ‘15’ are in a display waiting state, are also located at the right sides of items ‘7’ and ‘8.’ As shown in diagram 501 of FIG. 5A, since items ‘1’ to ‘8’ are arranged from the left to the right, the first boundary 53 of the item display allocation area corresponds to the boundary of the item display allocation area at the location where the item arrangement starts, and likewise, the second boundary 54 of the item display allocation area corresponds to the boundary of the item display allocation area at the location where the item arrangement ends. Since there are not any items in a display waiting state to the left direction of items ‘1’ and ‘2’ but there are items in a display waiting state are to the right of items ‘7’ and ‘8,’ the controller 160 controls the display unit 132 only to display the light image 55 at the second boundary 54.

When the screen shows items 51 arranged as shown in diagram 501 and the light image 55 is displayed at only the second boundary 54 of the item display allocation area, the user can recognize that there are no items in a display waiting state to the left of items ‘1’ and ‘2’ and there are items in a display waiting state to the right of items ‘7’ and ‘8.’ In that case, the user can also detect that items can be moved and displayed when he/she performs a touch movement gesture from right to left but no items can be moved and displayed when he/she performs a touch movement gesture from left to right. When the user performs a touch movement gesture from the right to the left, the controller 160 controls the display unit 132 to move and display icons according to the movement distance or the speed of the touch movement gesture.

Diagram 502 of FIG. 5A shows items after they experience a user's touch movement gesture in the horizontal direction on the screen shown in diagram 501 of FIG. 5A and are moved. That is, as shown in diagram 502, the screen removes items ‘1,’ ‘2,’ ‘3,’ and ‘4,’ shown in diagram 501, and newly displays items ‘9,’ ‘10,’ ‘11,’ and ‘12.’ In that case, items ‘13,’ ‘14,’ and ‘15’ are located at the right of items ‘11’ and ‘12’ and are in a display waiting state, and items ‘1,’ ‘2,’ ‘3’ and ‘4’ are located at the left direction of items ‘5’ and ‘6’ and are in a display waiting state. Therefore, the controller 160 controls the display unit 132 to display the light image 55 both at the first boundary 53 and second 54 boundary of the item display allocation area. When the screen shows items 51 arranged as shown in diagram 502 and the light image 55 is arranged both at the first 53 and second 54 boundaries of the item display allocation area, the user can recognize that there are items in a display waiting state to the left of items ‘5’ and ‘6’ and to the right of items ‘11’ and ‘12.’

As shown in diagram 503 of FIG. 5B, the screen shows eight items ‘1,’ ‘2,’ . . . , ‘8’ (51), an item display allocation area 52, a first boundary 53 of the item display allocation area, a second boundary 54 of the item display allocation area, and a light image 55. Unlike the screen shown in diagram 501 of FIG. 5A, the screen shown in diagram 503 of FIG. 5B arranges the eight individual items ‘1,’ ‘2,’ . . . , ‘8’ (51) horizontally in two vertically arranged rows each containing four items, in the item display allocation area 52. In this embodiment, as shown in diagram 503 of FIG. 5B, the first boundary 53 corresponds to the upper boundary of the item display allocation area 52 and the second boundary 54 corresponds to the lower boundary of the item display allocation area 52. In that case, items ‘1’ to ‘8’ are arranged in the item display allocation area, and the remaining items ‘9’ to ‘15’ are in a display waiting state below the items ‘5,’ ‘6,’ ‘7,’ and ‘8.’ Since there are no items in a display waiting state above items ‘1,’ ‘2,’ ‘3,’ and ‘4’ but there are items in a display waiting state below items ‘5,’ ‘6,’ ‘7,’ and ‘8,’ the controller 160 controls the display unit 132 only to display the light image 55 at the second boundary 54 as shown in diagrams 503 and 504.

When the screen shows items 51 arranged as shown in diagram 503 and the light image 55 is displayed at only the second boundary 54 of the item display allocation area, the user can recognize that there are only items in a display waiting state below the items ‘5,’ ‘6,’ ‘7,’ and ‘8.’ In that case, the user can also detect that items can be moved and displayed when he/she performs a touch movement gesture from the bottom to the top but that no items can be moved and displayed when he/she performs a touch movement gesture from top to bottom. When the user performs a touch movement gesture from the bottom to the top, the controller 160 controls the display unit 132 to move and display icons according to the movement distance or the speed of the touch movement gesture.

Diagram 504 of FIG. 5B shows items after they experience a user's touch movement gesture in the upper direction on the screen shown in diagram 503 of FIG. 5B and are moved. That is, as shown in diagram 504, the rows are vertically shifted such that screen removes the row containing items ‘1,’ ‘2,’ ‘3,’ and ‘4,’ shown in diagram 503, and newly displays the row containing items ‘9,’ ‘10,’ ‘11,’ and ‘12.’ In that case, items ‘13,’ ‘14,’ and ‘15’ are located below items ‘9,’ ‘10,’ ‘11,’ and ‘12’ and are in a display waiting state, and items ‘1,’ ‘2,’ ‘3’ and ‘4’ are located above items ‘5,’ ‘6,’ ‘7,’ and ‘8’ and are in a display waiting state. Therefore, the controller 160 controls the display unit 132 to display the light image 55 both at the first 53 and second 54 boundaries of the item display allocation area. When the screen shows items 51 arranged as shown in diagram 504 and the light image 55 is arranged both at the first 53 and second 54 boundaries of the item display allocation area, the user can recognize that there are items in a display waiting state above items ‘5,’ ‘6,’ ‘7,’ and ‘8’ and below items ‘9,’ ‘10,’ ‘11,’ and ‘12.’

As described above, when a case occurs where icons to be displayed are not all shown on a single screen but instead only part of the icons are to be shown on the screen, the mobile device displays a light image at the boundary portion of the item display allocation area, so that the user can recognize that there are items in a display waiting state by viewing the light image. In particular, the user can easily recognize where the items in a display waiting state (i.e., hidden items) are via the light direction and the location of the light image, and can guess which direction his/her touch movement gesture should be applied to display the hidden items on the screen.

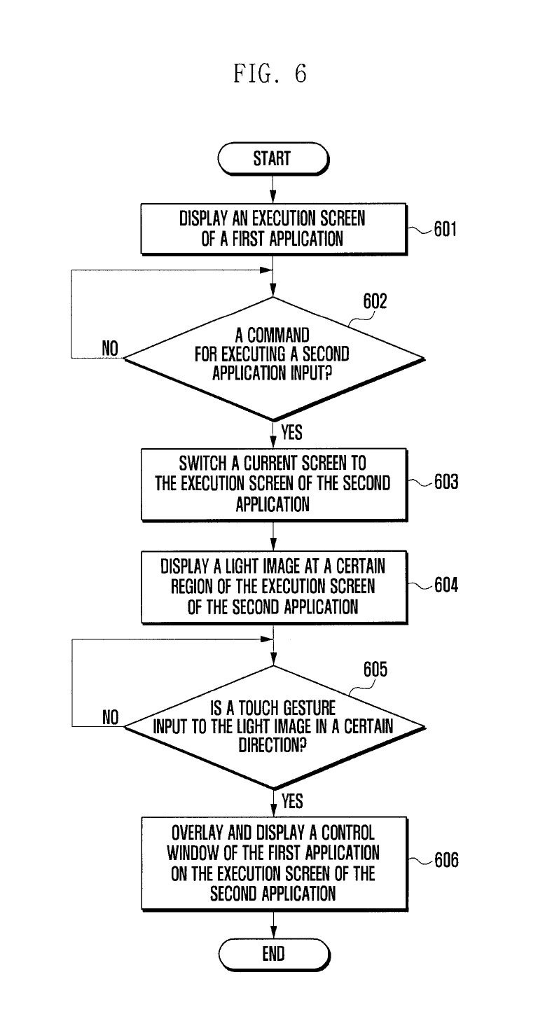

FIG. 6 illustrates a flowchart that describes a second embodiment of a method for providing a Graphical User Interface (GUI) related to a mobile device, according to the invention. The second embodiment relates to a method for providing a GUI that executes a number of applications in the mobile device. That is, the method provides a GUI that can display a control window to control another application on a screen on which one application is currently being executed and displayed or can switch a current screen to the execution screen of another application.

Referring to FIG. 1, at step (601), when the user inputs a command for executing a first application to the touch screen unit 130 or the key input unit 140, the controller 160 controls the display unit 132 to display an execution screen of the first application. The application refers to an application program stored in the program storage area of the storage unit 150 and is used as concept to perform all functions executable in the mobile device 100, for example, a call function, a text message transmission/reception function, photographs or moving images reproduction function, an audio reproduction function, a broadcast playback function, etc. The first application at step 601 serves to perform one of the functions executable in the mobile device 100. It is preferable that the execution screen of the first application at step 601 is implemented as a full screen in the display unit 132.

At step (601), the controller 160 may execute a number of applications via multitasking according to a user's input commands.

At step (602), while displaying the execution screen of the first application at step 601, the controller 160 determines whether the user inputs a command for executing a second application to the touch screen unit 130 or the key input unit 140. Step (602) takes into account a case in which one or more applications are being executed in the mobile device 100, and the user may additionally execute another application. That is, the user may input a command for executing a second application to the touch screen unit 130 or the key input unit 140. For example, when the execution screen of the first application shows a menu key to execute another application, the user can touch the menu key, thereby executing the second application. Alternatively, when the key input unit 140 includes a home key, the user can press it to return a screen to the home screen on the display unit 132 and then touch an icon on the home screen, thereby executing the second application.

At step (603), when the controller 160 detects a user's input command, it controls the display unit 132 to switch the execution screen from the first application into the second application. In that case, it is preferable that the execution screen of the second application is displayed as a full screen on the display unit 132.

After that, at step (604), the controller 160 controls the display unit 132 to display a light image on a certain region in the execution screen of the second application. Like in the second exemplary embodiment, the light image refers to an image of a light shape illuminating the display unit 132 in a certain direction. When the execution screen of the second application includes a number of items separated by line, the light image may be displayed in such a manner that light is designed as a shape to direct one of the items to the line between items. For example, when the execution screen of the second application serves to execute a text message application and displays rectangular items arranged in a vertical direction, the light image may be shaped as an image of a light that faces one of the items at the line dividing the items. Alternatively, the light image may be shaped as an image of a light that faces a direction opposite to a status display area of the mobile device at the line dividing the status display area and the main area of the screen. The status display area of the mobile device shows status information regarding the mobile device 100, such as RSSI, battery charge status, time, etc. A status display area for mobile devices is located at the top edge of the display unit 132 and is shaped as a rectangle. The bottom edge of the rectangular status display area is implemented as a line image and the remaining three edges correspond to boundary lines of the display unit 132. That is, the light image can be implemented as an image of a light that is located at the status display area and illuminates downwards therefrom. Alternatively, the light image can be implemented as an image of a light that is located at one of the boundary lines and illuminates to the center of the display unit 132 therefrom. The display unit 132 has a substantially rectangular shape. In that case, the light image may be implemented as an image of a light that faces the center of the display unit 132 at one of the four edges of the substantially rectangular display unit 132. In addition, the light image may be implemented as an image of a light that is located outside the display unit 132 and illuminates the inside from outside the display unit 132.

In another exemplary embodiment, the light image may be displayed at the corner of the display unit 132. Since the rectangular display unit 132 has four corners, the light image may be implemented as an image of a light that is located one of the four corners and illuminates the center of the display unit 132. In addition, the light image may be implemented as an image of a light that is located outside the display unit 132 and illuminates the inside from outside the display unit 132. It should be understood that the number of light images may be altered according to the number of applications that are being executed via multitasking, other than the second application.

For example, when there are four applications that are being executed via multitasking, other than the second application, the display unit 132 may display four light images at the four corners, respectively. If there are five or more applications that are being executed via multitasking, other than the second application, the display unit 132 may further display corresponding number of light images at the boundaries as well as four light images at the four corners.

At step (605), while the light image is displayed on the display unit 132 at step 604, the controller 160 determines whether the user inputs a touch gesture toward the light image in a certain direction on the touch screen unit 130. That is, the user touches the light image on the display unit 132 and then moves his/her touched position in a certain direction. It is preferable that the touched position is moved in the light illumination direction. That is, when the light image illuminates light downwards on the display unit 132, the user touches the light image and then moves the touch downwards. If the light image illuminates light in the right direction on the display unit 132, the user touches the light image and then moves the touch in the same direction.

In another exemplary embodiment, the controller 160 can also determine whether the user inputs the touch movement gesture with a distance equal to or greater than a preset value. Alternatively, the controller 160 also measures a holding time of a touch input by the user and then determines whether the measured touch holding time exceeds a preset time. In still another exemplary embodiment, the controller 160 can also determine whether the user only taps the light image via the touch screen unit 130 without the movement of the touched position at step 605.

Meanwhile, when at step (605) the controller 160 ascertains that the user inputs a touch gesture toward the light image in a certain direction at step 605, then at step (606) the controller controls the display unit 132 to overlay and display a control window of the first application on the execution screen of the second application. The control window of the first application may include only function keys to control the first application, and may alternatively further include additional function keys to controls applications other than the first application. When a number of applications are being executed before the second application is executed, the controller 160 can set the priority order of the executed applications and then display a control window for the highest priority application. For example, when the application priority order is set in order as a call application, a moving image playback application, and an audio playback application and these three applications are all being executed, the controller 160 controls the display unit 132 to display the control window for the call application. In addition, the controller 160 can detect the last executed application before the execution of the second application and can then control the display unit 132 to display a control window for the detected application. For example, when the user executes, in order, with multitasking, a call application, a moving image playback application, and an audio playback application, before the execution of the second application, the controller 160 can control the display unit 132 to display the control window for the last executed audio playback application. It is preferable that the control window of the first application is smaller in size than the execution screen of the second application. The control window of the first application is displayed as it gradually opens according to the movement direction and the movement distance of the user's input touch, toward the light image. When the controller 160 senses a user's input touch, it may control the display unit 132 to delete the light image. When the controller 160 senses a touch movement gesture, it may also control the display unit 132 to delete the light image. When the controller 160 obtains the movement distance of the user's touch movement gesture and concludes that it corresponds to a distance so that the control window of the first application can be completely open, it may also control the display unit 132 to delete the light image.

The controller 160 determines, via the touch screen unit 130, whether the user's touch movement gesture moves a preset distance so that the control window for the first application can be completely open. When the controller 160 ascertains that the user's touch movement gesture moves a distance less than the preset distance and releases therefrom, it controls the display unit 132 to delete the control window for the first application, partially opened, and to restore and display the light image. On the contrary, when the controller 160 ascertains that the user's touch movement gesture moves the preset distance, it controls the display unit 132 to completely open and display the control window for the first application and then to retain it although the user's touch is released.

The controller 160 determines whether the user's touch movement gesture moves a preset distance so that the control window for the first application can be completely open before the user's touch holding time exceeds a preset time. When the controller 160 ascertains that the user's touch holding time exceeds a preset time before the user's touch movement gesture moves the preset distance, it controls the display unit 132 to delete the control window for the first application, partially opened, and to restore and display the light image.

In another exemplary embodiment, at step (606) the controller 160 controls the display unit 132 to switch the execution screen from the second application to the first application. When the user touches the light image and then moves the touch in a certain direction, the controller 160 removes the execution screen of the second application currently displayed and then returns the execution screen of the first application displayed at step (601). When the controller 160 senses that the user's touch movement gesture moves a distance equal to or greater than a preset distance, it controls the display unit 132 to switch the execution screen of the second application to that of the first application. For example, when the user touches the light image and then moves the touch to the boundary of the display unit 132 in the light illumination direction, the controller 160 controls the display unit 132 to switch the execution screen of the second application to that of the first application.

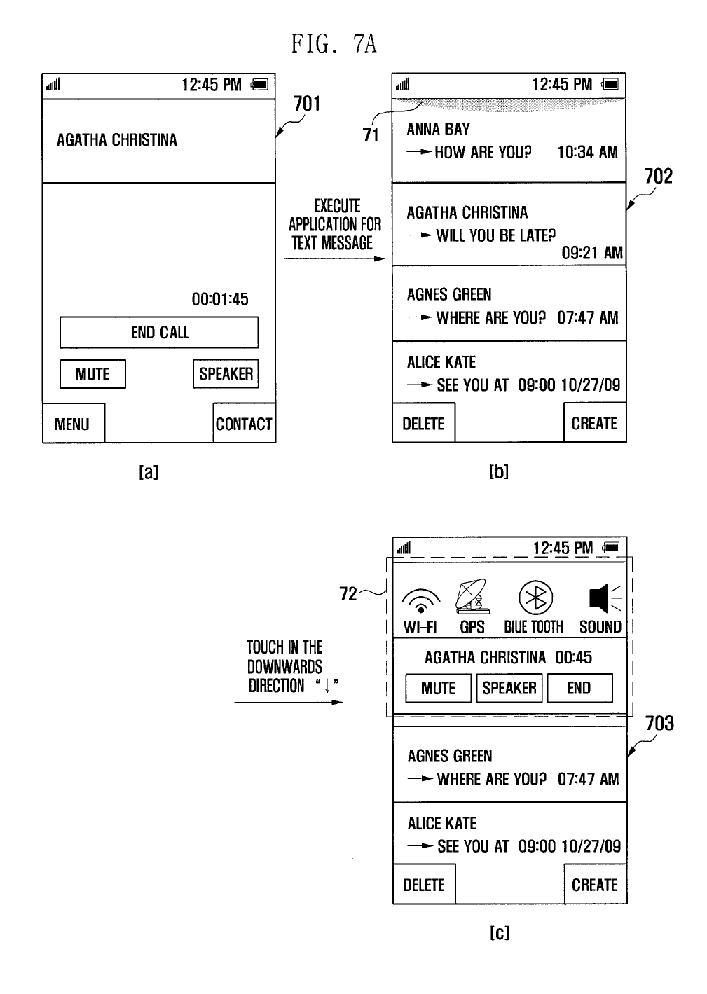

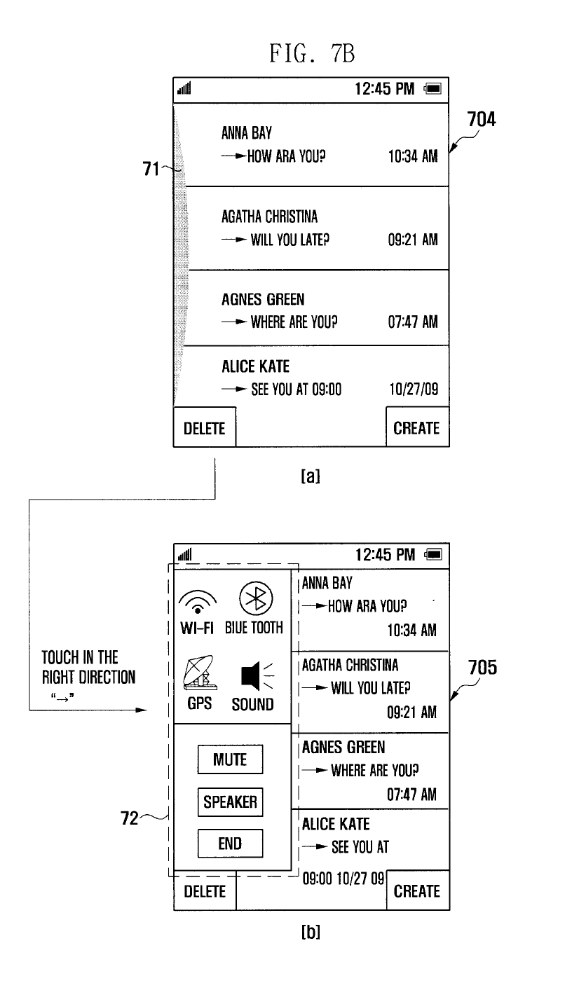

FIGS. 7A and 7B illustrate a first exemplary example of screens displayed on a mobile device 100, according to the second embodiment of a method for providing a GUI. FIG. 7A illustrates screens where the light image is displayed widthwise on the display unit 132, and FIG. 7B illustrates screens where the light image is displayed lengthwise on the display unit 132.

Diagram 701 of FIG. 7A shows an execution screen of a call application, including call keys such as ‘End call,’ ‘Mute,’ and ‘Speaker.’ When the user inputs a command for executing a text message application via the touch screen unit 130 or the key input unit 140 while a call application is being executed, the controller 160 controls the display unit 132 to switch the execution screen of the call application to that of the text message application. In that case, the controller 160 controls the display unit 132 to display a light image on the execution screen of the text message application.

Diagram 702 of FIG. 7A shows an execution screen of a text message application. The execution screen displays four items listed vertically, forming a list of received messages, and a light image 71 at the boundary line between the status display area, located at the top of the display unit, and a message item transmitted from ‘Anna Bay.’ The light image 71 may be displayed all over the boundary line or in part of the boundary line. When the user touches the light image and moves the touch downwards while the execution screen of the text message application is being displayed, the controller 160 controls the display unit 132 to overlay and display a control window to control the call application on the execution screen of the text message application.

Diagram 703 of FIG. 7A shows an execution screen of the text message application on which a control window 72 for a call application is overlaid. The control window 72 for a call application includes function keys for controlling a call application, such as ‘Mute,’ ‘Speaker,’ and ‘End,’ and the other function keys for executing a variety of applications other than the first application, such as ‘Wi-Fi,’ ‘Bluetooth,’ ‘GPS,’ ‘Sound,’ etc. While the text message application is being executed, the user can recognize that another application is also being executed according to whether the light image is displayed. When the user inputs a touch movement gesture in the light illumination direction of the light image, the controller 160 opens a control window to control the other applications.

FIG. 7B illustrates screens where the light image is displayed lengthwise on the display unit 132. It is assumed that the user inputs a command for executing a text message application while the execution screen of a call application is being displayed. Diagram 704 of FIG. 7B shows an execution screen of a text message application. The execution screen displays four items listed vertically, forming a list of received messages, and a light image at the left boundary line of the display unit 132. When the user touches the light image and moves the touch in the right direction, the controller 160 controls the display unit 132 to overlay and display a control window to control the call application on the execution screen of the text message application.

Diagram 705 of FIG. 7B shows an execution screen of the text message application on which a control window 72 for a call application is overlaid. The control window 72 for a call application includes function keys for controlling a call application, such as ‘Mute,’ ‘Speaker,’ and ‘End,’ and the other function keys for executing a variety of applications other than the first application, such as ‘Wi-Fi,’ ‘Bluetooth,’ ‘GPS,’ ‘Sound,’ etc.

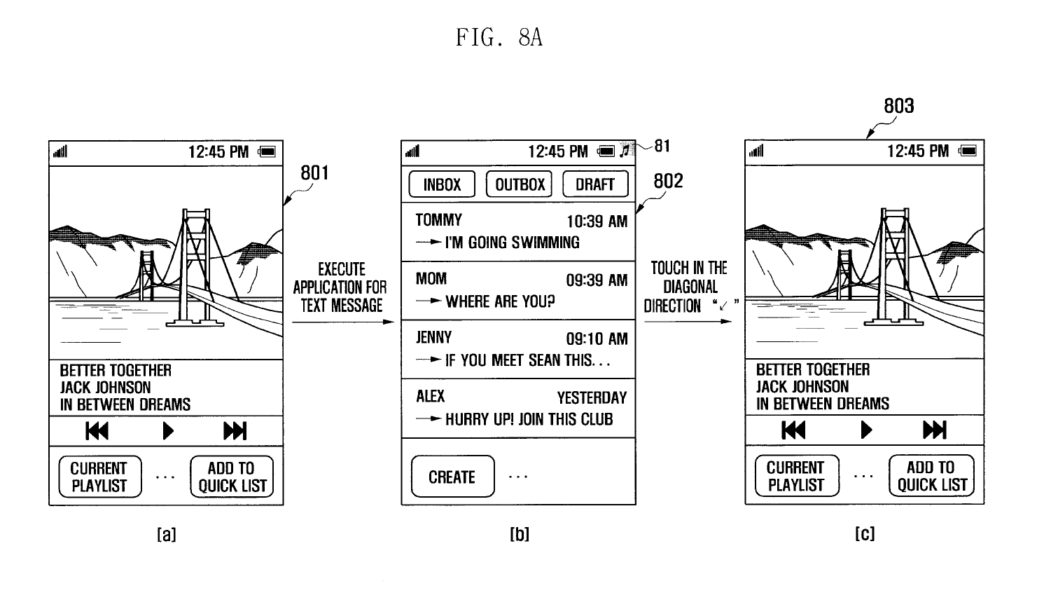

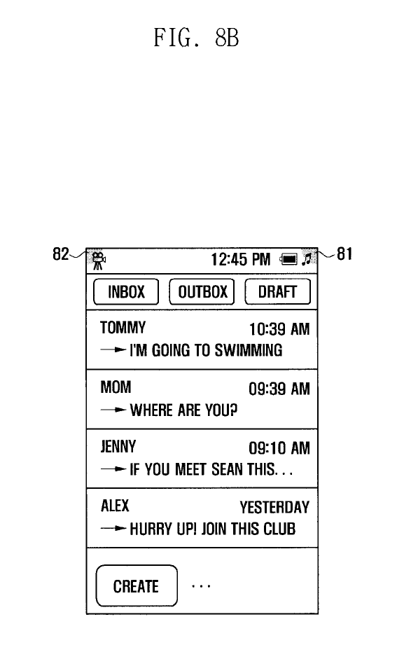

FIGS. 8A and 8B illustrate a second exemplary example of screens displayed on a mobile device, according to the second exemplary embodiment of a method for providing a GUI. This second exemplary embodiment relates to a method for providing a GUI that displays a light image at the corners of the display unit 132.

FIG. 8A shows screens when there is one application being executed in addition the applications currently displayed. FIG. 8B shows a screen when there are two applications being executed in addition to the applications currently displayed.

Diagram 801 of FIG. 8A shows an execution screen of an audio playback application, for example. When the user inputs a command for executing a text message application via the touch screen unit 130 or the key input unit 140 while an audio playback application is being executed, the controller 160 controls the display unit 132 to switch the execution screen of the audio playback application to that of the text message application. In that particular case, the controller 160 controls the display unit 132 to display a light image on the execution screen of the text message application.

Diagram 802 of FIG. 8A shows an execution screen of a text message application. The execution screen displays four items listed vertically, forming a list of received messages, and a light image 71 at the top right corner of the display unit 132. The light image 71 includes a ‘musical note’ image to indicate an audio playback application. When the user touches the light image and moves the touch in a diagonal direction, i.e., in the bottom left direction, while the execution screen of the text message application is being displayed, the controller 160 controls the display unit 132 to switch the execution screen of the text message application to that of the audio playback application again.

Diagram 803 of FIG. 8A shows the execution screen of the audio playback application to which the execution screen of the text message application is switched again. While the text message application is being executed, the user can recognize, via the light image, what applications are currently being executed via multitasking. When the user touches the light image and then moves the touch in the light illumination direction, the controller 160 controls the display unit 132 to switch the current screen to an execution screen of an application that is being executed via multitasking.

FIG. 8B shows an execution screen of a text message application while an audio playback application and a moving image playback application are being executed via multitasking. The execution screen shows light images 81 and 82 at the corners at the top right and top left of the display unit 132. The light image 81 at the top right corner includes a ‘musical note’ image to indicate an audio playback application. Likewise, the light image 82 at the top left corner includes a ‘photographing tool’ image to indicate a moving image playback application. When the user touches the light image 81 with the ‘musical note’ image and then diagonally moves the touch in the same direction as the light illumination direction of the light image 81, i.e., in the bottom left direction, the controller 160 controls the display unit 132 to display the execution screen of the audio playback application. Likewise, when the user touches the light image 82 with the ‘photographing tool’ image and then diagonally moves the touch in the same direction as the light illumination direction of the light image 82, i.e., in the bottom right direction, the controller 160 controls the display unit 132 to display the execution screen of the moving image playback application.

As described above, when one application is currently executed in the mobile device 100, a light image may also be displayed that can allow the user to execute another application on the screen of the currently executed application. The light image may be displayed: in a certain region on the screen of the currently executed application; in a region between items included the execution screen of the application; on the boundary line of the display unit 132; or in the corner of the display unit 132. Applications displayed via a light image may be a user's frequently used applications or a user's selected applications. For example, when an audio playback application and a moving image playback application have been set as applications displayed via a light image and a call application is currently executed in the mobile device 100, the controller 160 can control the display unit 132 to display an execution screen of the call application on which the light images corresponding to the audio playback application and the moving image playback application are also displayed.

In another exemplary embodiment, the light image may be displayed in different colors according to the features of display screens or the features of applications. For example, in the method for providing a GUI for searching for items according to the first embodiment of the invention, the light image may be displayed in blue. Likewise, in the method for providing a GUI to open a control window of an application executed via multitasking according to the second embodiment of the invention, the light image may be displayed in green. In still another exemplary embodiment, the color of the light image may also be determined according to the degree of importance of applications, the degree of urgency, etc. For example, when the mobile device includes applications requiring urgent attention, such as a call application, a text message application, an alert application, etc., the light image allowing a user to open a control window of such applications may be displayed in red. Also, a person of ordinary skill in the art should appreciate that the brightness of the light image can increase, for example, or the size of the light image, for example, corresponding to urgency or the number of non-displayed images. It is also possible to manipulate a transducer in degrees that correspond to urgency and/or volume of non-displayed items.

As described in the foregoing exemplary embodiments of the invention, mobile devices can provide use convenience to users. The user can recognize, via the light image displayed on the screen of the mobile device, whether there is additional information to be displayed other than the currently displayed information. The user can also recognize, via the light image displayed on the screen of the mobile device, whether he/she should input a touch movement gesture to display additional information that is not displayed on the current screen. In addition, when a number of applications are executed in the mobile device, the user can recognize, via the light image displayed on the execution screen of an application, whether another application is being executed, and can control another application using a control window created via the light image. Alternatively, when a number of applications are executed in the mobile device, the user can recognize, via the light image displayed on the execution screen of an application, what types of applications are currently executed, and can perform the alteration of execution screen of the application by applying a certain type of gesture toward the light image.

Although exemplary embodiments of the invention have been described in detail hereinabove, it should be understood that many variations and modifications of the basic inventive concept herein described, which may be apparent to those skilled in the art, will still fall within the spirit and scope of the exemplary embodiments of the invention as defined in the appended claims.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor, microprocessor (controller) or the programmable hardware include memory components, e.g., RAM, ROM, Flash, etc. that may store or receive software or computer code that when accessed and executed by the computer, processor or hardware implement the processing methods described herein.

What is claimed is:

1. A method for providing a Graphic User Interface (GUI) in a mobile device, comprising:
determining whether there is an additional item to be displayed by a display unit, other than at least one item currently arranged in an item display allocation area; and
displaying, when there is an item to be displayed, an indicator comprising an image object, shaped as a certain shape, at a boundary of the item display allocation area at which the item to be displayed is created.

2. The method of claim 1, wherein the determination comprises:
determining whether items are movable in an item arrangement direction in which the items are arranged, or in a direction opposite to the item arrangement direction, in a state where at least one item is currently arranged in the item display allocation area.

3. The method of claim 2, wherein the display of an image object comprises:
displaying, when items are movable in the item arrangement, an image object, shaped as a predetermined shape, at a first boundary portion of the boundary of the item display allocation area at which the item arrangement starts; or
displaying, when items are movable in a direction opposite to the item arrangement, an image object, shaped as a predetermined shape, at a second boundary portion of the boundary of the item display allocation area at which the item arrangement ends.

4. The method of claim 1, wherein the image object shaped as a predetermined shape comprises:
a light image of light illumination.

5. The method of claim 1, further comprising:
arranging and displaying a column of part of a plurality of items in the item display allocation area in a certain direction, wherein a number of items have been arranged in a preset order.

6. The method of claim 5, wherein the determination comprises:
determining whether an item, displayed in the first order in the item display allocation area, is the highest priority item of a plurality items; or
determining whether an item, displayed in the last order in the item display allocation area, is the lowest priority item of a plurality of items.

7. The method of claim 4, wherein the image object of light illumination is shaped as a light illuminating toward a direction to which the item to be displayed is created.

8. The method of claim 1, further comprising:
sensing whether a touch movement gesture is input;
moving and displaying items according to the sensed touch movement gesture;
determining whether there is an item to be displayed at the location where the items are moved; and
displaying, when there is an item to be displayed, an image object, shaped as a predetermined shape, at the boundary of the item display allocation area at which the item to be displayed is created.

9. The method of claim 1, further comprising:
measuring a period of time that a graphic object, shaped as a predetermined shape, is displayed; and
deleting, when the measured period of time exceeds a preset period of time, the graphic object.

10. A method for providing a Graphic User Interface (GUI) in a mobile device, comprising:
determining, while at least one application including a first application is being executed, whether a command to execute a second application has been input;
displaying a graphic object shaped as predetermined shape on a specific region of an execution screen of the second application;
sensing whether a touch gesture has been input to the graphic object; and
displaying a screen related to the first application according to the sensed touch gesture.

11. The method of claim 10, wherein the screen related to the first application is overlaid on at least a portion of the execution screen of the second application.

12. The method of claim 10, wherein the display of a graphic object comprises:
displaying, when the execution screen of the second application includes a number of items and the items are divided via a line, the graphic object on the line between the items.

13. The method of claim 10, wherein the display of a graphic object comprises:
displaying, when the screen of the mobile device has a rectangular shape, the graphic object in at least one of four corners of the rectangular screen.

14. The method of claim 10, wherein the graphic object comprises:
a light image of light illumination.

15. The method of claim 14, wherein the sense of a touch gesture comprises:
sensing a touch input toward the light image and a touch movement gesture moving in a light illumination direction of the light image.

16. The method of claim 15, wherein the display of a screen related to the first application comprises:
creating a control window for controlling the first application and overlaying and displaying the control window on the execution screen of the second application, according to a movement distance of the touch movement gesture.

17. The method of claim 10, wherein the display of a screen related to the first application comprises:
switching display of the execution screen from the second application to the first application.

18. The method of claim 10, wherein the display of a screen related to the first application comprises:
displaying, when a plurality of applications including the first application are being executed, a screen related to one of the executed applications that is set as the highest priority order.

19. The method of claim 10, wherein the display of a screen related to the first application comprises:
displaying, when a plurality of applications including the first application are being executed, a screen related to one of the executed applications that is executed last.

20. A mobile device comprising:
a display unit for displaying screens; and
a controller for controlling the display unit to arrange and display at least one item on an item display allocation area, determining whether there is an item to be displayed other than said at least one item,
wherein the controller further controls, when there is an item to be displayed, the display unit 132 to display an indicator comprising an image object, shaped as a predetermined shape, at a boundary of the item display allocation area at which the item to be displayed is created.

21. The mobile device of claim 20, further comprising:
a touch screen unit for sensing an input of a user's touch gestures,
wherein the controller:
executes at least one application including a first application;
receives a user's command for executing a second application via the touch screen unit;
controls the display unit to display a graphic object, shaped as a predetermined shape, in a region of an execution screen of the second application;
controls the touch screen unit to sense a user's touch gesture input to the graphic object; and
controls the display unit to overlay and display a control window of the first application on the execution screen of the second application.

22. The mobile device of claim 20, further comprising:
a touch screen unit for sensing an input of a user's touch gestures,
wherein the controller:
executes at least one application including a first application;
receives a user's command for executing a second application via the touch screen unit;
controls the display unit to display a graphic object, shaped as a predetermined shape, in a region of an execution screen of the second application;
controls the touch screen unit to sense a user's touch gesture input to the graphic object; and
controls the display unit to switch the execution screen from the second application to the first application, according to the sensed touch gesture.
